(19) United States
(12) Patent Application Publication
(10) Pub. No.: US 2010/0312627 A1
(43) Pub. Date: Dec. 9, 2010

(54) SYSTEMS AND METHODS FOR FUNDS PROCESSING IN POSTAGE DISTRIBUTION ENVIRONMENTS

(75) Inventors: Amine Khechef, Cupertino, CA (US); Scott Montgomery, Los Altos, CA (US); Harry Whitehouse, Portolo Valley, CA (US)

Correspondence Address: PILLSBURY WINTHROP SHAW PITTMAN, LLP, P.O. BOX 10500, MCLEAN, VA, 22102, US

(73) Assignee: PSI SYSTEMS, INC., PALO ALTO, CA (US)

(21) Appl. No.: 12/738,958

(22) PCT Filed: Oct. 21, 2008
(86) PCT No.: PCT/US08/80638

§ 371 Date: May 27, 2010

Related U.S. Application Data
(60) Provisional application No. 60/981,768, filed on Oct. 22, 2007.

(51) Int. Cl. G06Q 30/00; G06Q 40/00; H04N 1/60

(52) U.S. Cl. 705/14.17; 705/14.23; 705/39; 705/14.31; 705/14.1; 705/14.34; 358/1.9

(57) ABSTRACT

Provided herein are systems and methods for processing funds in distribution environments such as internet-based postage distribution environments. In exemplary embodiments, incentive programs are administered and managed within the system. These incentive programs can include discount programs, rebate programs and revenue sharing programs.

### FIELD OF THE INVENTION

The inventions described herein relate generally to the processing of funds in postage distribution environments such as internet-based postage distribution environments.

### BACKGROUND OF THE INVENTION

A growing number of postage transactions take place in internet-based postage distribution environments. These environments generally involve the distribution of postage from a vendor to a customer over the internet. Typically, the customer will provide funds in exchange for postage that can be printed directly onto an envelope or onto a medium that can be transferred to an envelope or package. The vendor is typically authorized by the national postal authority, such as the United States Postal Service (USPS) for shipments originating in the United States. The vendor will conduct postage transactions with thousands of customers and supply postage to these customers in real-time. The customers can be individual users or corporate entities and the like. The vendor can act as a “go-between” with regards to funds transferred from the customers to the postal authority. Generally, the vendor will charge the customer a service fee for allowing the customer to use the internet-based service. This service fee is in addition to the standard postage rate charged to the customer. In some cases the rates charged to the customer can be slightly discounted, such as, for instance, the discount authorized by the USPS for certain electronic services like Delivery Confirmation or online customs forms. For example, Delivery Confirmation, which is a form of tracking, can be 0.55 dollars for priority mail at a retail counter but free if the customer uses an internet-based system.

This arrangement is inefficient in certain regards. For instance, it requires the customer to pay fees to both the postal authority and the vendor, which can be confusing to the customer thereby serving as a disincentive to the use of internet-based systems. This arrangement also does not allow the administration of efficient incentive programs amongst the USPS, vendor and/or customer.

Accordingly, improved systems and methods for funds processing in postage distribution environments are needed.

### SUMMARY

The systems and methods are described by way of embodiments that are exemplary only and in no way should be construed as limiting beyond the express language of the appended claims. Provided herein are systems and methods regarding the processing of funds in postage distribution environments such as internet-based environments. These funds can be related to the provision of discounts and/or selective rebates to postage-purchasing customers. The processed funds can also be a part of a revenue sharing structure implemented between a postage distributing vendor and the authority on whose behalf the vendor is acting.

Other systems, methods, features and advantages will be or will become apparent to one with skill in the art upon examination of the following figures and detailed description. It is intended that all such additional systems, methods, features and advantages be included within this description, be within the scope of the systems and methods described herein, and be protected by the accompanying claims.

### BRIEF DESCRIPTION OF THE FIGURES

The details of the invention, both as to its structure and operation, may be gleaned in part by study of the accompanying figures, in which like reference numerals refer to like parts. The components in the figures are not necessarily to scale, emphasis instead being placed upon illustrating the principles of the inventions. Moreover, all illustrations are intended to convey concepts, where relative sizes, shapes and other detailed attributes may be illustrated schematically rather than literally or precisely.

FIGS. 1 and 2 are block diagrams depicting exemplary embodiments of postage environments in which the systems and methods can be implemented.

FIG. 3 is a block diagram depicting an exemplary embodiment of a transaction management system.

### DETAILED DESCRIPTION

The systems and methods described herein will be done with respect to postage transactions and postage distribution environments having a national (or common) postal authority. However, it should be understood that these systems and methods are not limited to such and can also be used with commercial carriers such as FedEx, UPS, DHL and the like.

Offering incentive programs like discounts, rebates and revenue sharing to low volume shippers (e.g., individuals) and high volume shippers (e.g., Amazon.com, LL Bean, etc.) can be difficult in the complex and historically constrained environments of the national postal authorities (e.g., the United States Postal Service (USPS), the French LaPoste, Canada-Post and comparable authorities across the world). These environments can be more complicated than managing a discount program for other volume package commercial carriers (e.g., FedEx, UPS, DHL and the like). Medium and high volume customers of the commercial carriers are typically on a periodic billing cycle, where shipping labels are created as needed and the total amount is billed at the end of the cycle, e.g., 7 days, 30 days or otherwise. The packages contain information (typically a barcoded account number) identifying the shipper, and the customer's use of the shipping service is monitored by scanning the packages at induction or during the delivery cycle. A tally of all the packages shipped, as well as relevant information pertaining thereto, over a given cycle is assembled by the commercial carrier and then an invoice is presented to the shipper, who pays after the fact. Such a setup facilitates the application of discounts, rebates and revenue sharing, whereas payments to postal authorities typically occur on a transaction-by-transaction basis and prior to shipping.

Furthermore, packages shipped by the commercial carriers never contain any indication of how much was paid for shipping. The operations group for each carrier really only needs to record the weight, destination, and customer account number for each package. This fact is valued by the shippers as the customer does not know how much of the “shipping and handling fee” was actually devoted to shipping.

In comparison, the models of the national postal authorities can be vastly different. For instance, USPS customers must prepay postage and have that postage applied to each and every package. Some 40,000 post office induction points check the postage on incoming packages and return those that have less postage than required. Thus, it is very difficult to offer, for instance, discount programs to USPS package shippers without an overwhelming effort to apprise the hundreds of thousands of USPS employees of the details of each discount program (which might vary by shipper). It is also noteworthy that, prior to 2007 in the United States, the USPS was forbidden to offer discounts on domestic packages. The Postal Reform Act of 2007 gives the USPS much greater pricing flexibility in product lines which are considered “competitive”—such as packages.

A centralized postage dispensing model has been described in U.S. Pat. No. 6,005,945, entitled “System and Method for Dispensing Postage Based on Telephonic or Web Milli-transactions,” which is fully incorporated herein by reference. The present description will, among other things, show how the centralized postage system can easily manage any number of incentive programs without adversely impacting the field operations of the national postal authority.

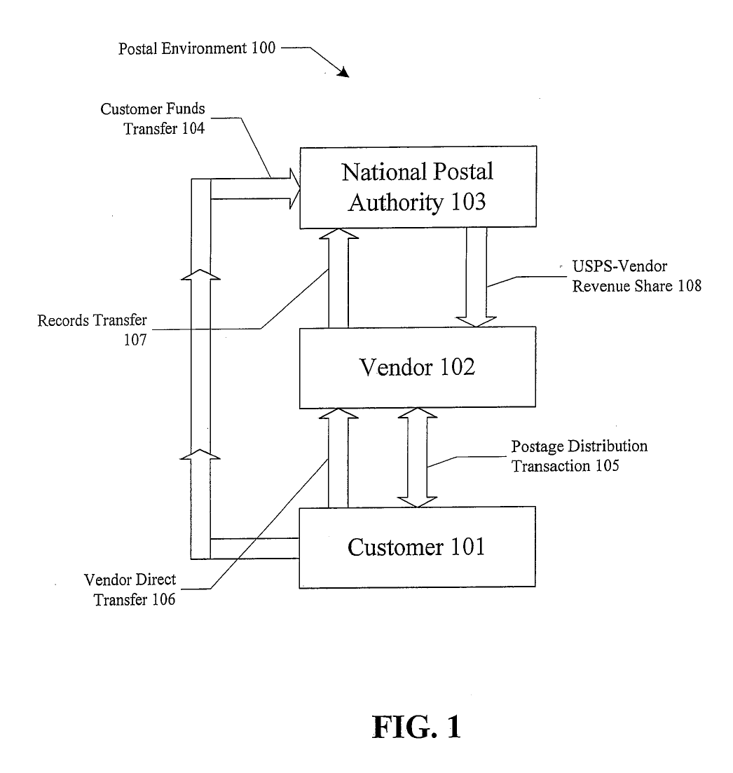

FIG. 1 is a block diagram depicting an exemplary embodiment of postal environment 100. Here, national postal authority 103 transacts with postage distribution vendor 102, which in turn transacts with multiple customers 101, which can be any entity utilizing the services of postal authority 103. For ease of illustration, only one of customers 101 is shown. For ease of discussion, the systems and methods described herein will be done so with reference to the USPS as an exemplary national postal authority 103, although it should be understood that these concepts can be applied to any national postal authority. In addition, unless otherwise noted, the systems and methods described herein can be applied to commercial carriers as well (e.g., Federal Express, UPS, DHL and the like).

The systems and methods described herein allow for the implementation of incentive programs within postal environment 100. Exemplary incentive programs can include discount programs, selective rebate programs and revenue sharing programs. Discount and rebate programs generally refer to programs that incentivize customer 101 to purchase postage with postal authority 103, preferably through vendor 102. A “discount” generally refers to a deduction (or refund of an amount corresponding to the deduction if processed at the time of full payment) from the full or standard shipping charge that is applied at the time of billing or payment. A “rebate” generally refers to all other customer incentive programs, e.g., a return to the customer of a portion of the full or standard shipping charge after the time of payment by the customer, or a transfer or provision of some item of value (cash, credit or otherwise) bearing relation to an amount paid by the customer, and the like. Incentive programs like “reward” programs are intended to qualify as rebates under this definition. Revenue sharing programs generally refer to programs that compensate the vendor, for instance, as an incentive for vendor 102 to sell postage to customer 101 or to compensate vendor 102 for the provision of a service to customer 101, such as technical support.

The manners in which the incentive programs are implemented are dependent upon the needs or desires of the parties. Accordingly, the foregoing description is intended to encompass a broad range of program designs ranging from simple to complex. For instance, the incentive programs can be implemented based simply on the amount of postage purchased or sold, regardless of the class or type of postage purchased. Conversely, the incentive programs can be implemented based upon a more complex matrix of criteria, such as these set forth below.

The incentive programs can be implemented based upon a criteria set that takes into account certain objective metrics (as applied to postage purchased by customer 101 or postage sold by vendor 102) including, but not limited to, any combination of the following: postage classes (e.g., priority overnight, first, etc.), postage types (e.g., package, envelope, etc.), parcel volume, parcel weight, postage value, and the like. Further, the incentive programs can be implemented based upon subjective metrics such as customer/vendor status (e.g., certain customers/vendors can be deemed as relatively more valuable) or hidden metrics such as mail piece profit margin for postal authority 103 and/or vendor 102.

Application of the incentive program can be on a transaction-by-transaction basis or on an aggregate basis calculated periodically (e.g., daily, weekly, bi-weekly, monthly and the like). The incentive programs can make use of fixed or variable designs, or any combination thereof. For instance, discounts/rebates could be calculated based on set dollar amounts, set percentages, or formulas that result in discounts that vary based on the inputs to the formula. Discounts can be applied based on the prospective performance of the customer so as to be incorporated at the time of billing, which typically occurs upfront.

To further illustrate the flexible nature in which the incentive program can be implemented, the following exemplary embodiments pertain to incentive programs that are based, at least in part, on mail piece volume. For instance, in one exemplary embodiment, an incentive program (e.g., a revenue share with vendor 102 or a discount/rebate to customer 101) can include a fixed amount applied to a postage volume purchases up to a first limit, with differing set percentages based on postage types for purchases up to a second limit, and so forth.

In another exemplary embodiment, an incentive program can be applied if a customer 101 meets a certain minimum volume requirement. In yet another exemplary embodiment, an incentive program payment (e.g., discounts, rebates or revenue shares) can be two percent of the aggregate postage value if customer 101 prints postage for three hundred packages in a month and three percent if customer 101 prints postage for five hundred packages in a month. Those skilled in the art will readily recognize the many possible variations that can be implemented in terms of relating the monetary amount to the amount of volume.

In another exemplary embodiment pertaining to revenue sharing, the program is implemented based on the volume of mail pieces shipped across all customers 101 of vendor 102 and not based on a strictly per customer basis.

As mentioned, any combination of any number of criteria can be used as a basis for the incentive program. For instance, an incentive program can be based on both the volume of postage printed by customer 101 as well as the class of postage printed by that customer 101. In one exemplary embodiment, the incentive program applies only to customers 101 that print a minimum daily and/or monthly volume of postage, and then only to the customer's volume that belongs to an eligible mail class.

For example, a revenue share incentive program can be structured such that vendor 102 only receives a revenue share if customer 101 satisfies a minimum volume requirement of three hundred postage pieces per month, and that domestic and international mail pieces are eligible for a 2% rebate while first class pieces are not eligible. Customer 101 might satisfy the minimum volume by printing postage for three hundred pieces, two hundred of which are domestic priority pieces worth $1000, fifty of which are international priority pieces worth $500, and fifty of which are first class pieces worth $50. In an example where the incentive program is a revenue sharing program, vendor 102 can receive a 2% revenue share only on the domestic and international priority mail pieces for a total amount of 2%×$1500=$30. A postage credit rebate to customer 101 can be applied in the same manner, giving customer 101 a $30 rebate applied retroactively at the end of the chosen time period.

In another exemplary embodiment where the incentive program is a revenue share program, the share can be based on the quantity of postage indicia (regardless of weight or class) that has been prepared by vendor 102, on the basis that the postage indicia prepared by vendor 102 are more readily processed by the USPS's automated processing and routing equipment, and is thus less expensive for the USPS to handle.

Prior to describing the implementation of these incentive programs in greater detail, it is helpful to first describe how the underlying funds are processed. A particular customer 101 preferably transfers funds by way of vendor 102 in exchange for the ability to print postage. This transfer is shown as customer funds transfer 104. This transfer can encompass what is sometimes referred to in the field as a “re-credit,” i.e., the crediting of funds to a customer's account. Transfer 104 is depicted with a broken line to indicate that the funds can be transferred through vendor 102, or the funds can be transferred indirectly with the vendor 102 acting as a “go-between,” such that the vendor 102 facilitates the transaction by relying on a financial service provider (e.g., a credit card company bank, on-line service, and the like). The funds are preferably transferred by systems controlled by the financial service providers and can be done so in any manner, typically via credit card transactions, ACH transactions (electronic checking), or direct wire transfers and the like.

Customer 101 can transfer funds on a postage transaction-by-transaction basis (e.g., each time an indicia is printed) or, preferably, as a lump sum to be stored in a postage account against which later postage purchases can be applied. Vendor 102 can track the current account balance for customer 101 to ensure adequate funds are present to complete a postage purchase transaction. Vendor 102 typically tracks the account balances in a postage-evidencing unit, which can be specialized hardware capable of performing with a high degree of security, usually physically located with the vendor itself. The postage-evidencing unit required by the USPS is referred to in their IBIP specifications as a postage storage device (PSD). It is further contemplated that vendor 102 can temporarily hold the actual monetary funds should national postal authority 103 (or commercial carrier) permit.

Preferably, to obtain postage, customer 101 sends a postage request to vendor 102. Vendor 102 preferably validates customer 101 and the request and verifies that customer 101 has adequate funds in the respective account to cover the transaction, or verifies that the amount of funds transferred with the request is sufficient. If the transaction is approved, vendor 102 will generate data corresponding to a postage indicia (either the indicia image itself or some amount of data that can be used to create the indicia image) and transmit that postage indicia data to customer 101 electronically. This transaction is depicted as postage distribution transaction 105. Preferably, funds transfer 104 and postage distribution transaction 105 occur via the internet (e.g., using an internet protocol) although other communication mediums can be utilized. Customer 101 is then free to use the received postage indicia as desired. For example, the customer can directly print the postage indicia onto an envelope or onto a medium that can be transferred to a mail piece.

Typically, all funds originating from the customer will be transferred directly to postal authority 103. However, some or all of the funds from the customer can be directed to (or retained by) vendor 102. This transfer is shown as vendor direct transfer 106 in FIG. 1. Vendor direct transfer 106 preferably occurs through a third party financial services provider (not shown), although vendor 102 can act in that capacity if desired. The funds transmitted in transfer 106 preferably correspond to the service fee charged independently by vendor 102, although it can correspond to any financial arrangement governing the relationship between postal authority 103 and vendor 102, including revenue sharing programs, as will be described hereinafter. Preferably, vendor 102 will manage the division of funds between postal authority 103 and vendor 102 according to the respective financial arrangement.

As mentioned above, numerous historical constraints and financial controls are imposed by the various national postal authorities 103, which can hinder competition with other carriers in the industry. For instance, postal authorities 103 typically demand that all funding events for a given postage-evidencing unit are duly recorded, and that the associated funds are transferred from customer 101 to postal authority 103 in a timely manner. This process is further complicated by the fact that there are numerous postage vendors operating within a given country, each supporting a plurality of physical (e.g., postage meters) or non-physical (e.g., virtual) postage-evidencing units.

For tracking account balances, the USPS requires that vendor 102 maintain various registers in the postage-evidencing unit and periodically communicate those values to the USPS. This communication is depicted as records transfer 107. In one exemplary embodiment, these registers include an ascending register, a descending register and a control register. Each postage account preferably has these or one or more equivalent data storage structures associated with it. A new account without a balance will have a value of zero assigned to each register.

When a postage-evidencing unit is assigned to a user, he or she must add funds to the unit before any postage indicia can be printed. Consider the example where the end user buys 100 dollars' worth of postage initially. In a typical postage environment, this “re-credit” operation results in both the control register and descending registers increasing by 100.

When the first indicium is created, the descending register is reduced by the amount of the indicium and the ascending register is increased by the same amount. For instance, if a 0.50 dollar indicium is printed, the descending register would be 99.50 and the ascending register would become 0.50. The control register preferably records the absolute value or credit to the account. The control register remains unchanged for an indicium printing event.

Indicium may be created as long as the descending register value is greater than zero and sufficiently large to cover the cost of the indicium. An indicium request should always be less than the descending register (else adequate funds would not be present to cover the cost of the indicium). The descending register reflects the remaining balance on the postage-evidencing unit. Alternatively, this is the amount of postage the unit is currently authorized to print. The ascending register is generally the ever-increasing sum total value of all postage indicia created by that account over its lifetime.

The USPS generally requires that a record of every transaction be communicated to the USPS—typically within 24 hours. This record will generally contain the identification number of the postage-evidencing device, the date/time, the amount of the re-credit, the method of re-credit, the ascending register value, the descending register value and the control register value.

The USPS typically retains a record of prior re-credit transactions so that the new transaction can be audited. For instance, the newly received control register value should, equal the prior control register value plus the re-credit value. The sum of the ascending register and descending register values should always equal the value in the control register (in both the current and all prior transactions). The ascending register from the current transaction is preferably always greater than or equal to that of the prior transaction.

A significant reason for these cross-checks is to reconcile the daily flow of actual funds into the USPS. As mentioned, funds are typically collected via credit card transactions, ACH transactions (electronic checking), or direct wire transfers and the like, using systems controlled by third party financial service providers, and the funds typically arrive in daily batches reflecting the prior-day's transactions.

The principal audit check performed by the USPS compares the funds actually received with the total value of the re-credits (reflected in the record transferred at 107). In a conventional environment, the sum total of all credit card, ACH, and wire receipts and the like should equal the sum total of the re-credits processed in the same time period. Any difference would trigger an audit by either the USPS or vendor 102.

The systems and methods described herein provide for a mechanism by which discounts can be applied such that postal authority 103 is informed that a discrepancy between the value of a printed indicium and the value of funds paid for that indicium is part of an authorized incentive program.

In one exemplary embodiment, discounts, revenue sharing and certain postage credit rebates can be implemented by performing a re-credit operation without an associated real funds transfer to postal authority 103. This “funds-less” re-credit operation can be used to issue funds in the form of postage credit to the end customer 101 or vendor 102 (vendor 102 can then translate this credit to real funds by closing the account to which the credit is posted and issuing a money refund to itself). This embodiment provides for register manipulations in a manner that still allows for a funds cross-check, while providing a detailed audit trail of all transactions used to issue discounts, rebates and revenue sharing.

Preferably, the USPS is notified that the present transaction is a “funds-less” re-credit operation by inclusion of an appropriate flag within the existing data record transferred in records transfer 107. When communicating with the USPS, this record can be the CMRS record. Every change to the registers of an account (e.g., the “balance”) can be communicated to the USPS as part of this CMRS (Centralized Meter Resetting System) record. The format of this record is defined by the USPS and typically includes the following values (with exemplary decimal character lengths in parentheses):

### RecordType As String (1)

### SerialNumber As String (11)

### TransactionDate As String (26)

### LPOZipCode As String (5)

### FinanceNumber As String (6)

### TransactionAmount As String (18)

### AscendingRegisterBefore As String (18)

### DescendingRegisterBefore As String (18)

### ActivityType As String (3)

### InspectionDueDate As String (8)

### CMRSOMASAcctNbr As String (15)

### FA_Code As String (3)

### FA_SubCode As String (5)

### CMLSLicenseNbr As String (10)

### Model As String (15)

### Payment_Type As String (2)

The last field, “Payment Type,” can be used to distinguish the method of payment. The following are typical accepted USPS values for the method of payment:

### 01—Credit Card

### 02—ACH Debit

### 03—ACH Credit

### 04—Check

### 05—CMRS Lock Box

### 06—Fed Wire

### 07—Providers Advance

### 98—No Payment

### 99—Other

In this embodiment, when the record is associated with a funds-less re-credit operation, the appropriate flag is preferably included within the “Payment Type” field. Any code or codes can be used such that the USPS is informed that it corresponds to the funds-less recredit operation. For instance, a new code can be added (e.g., any of 08 through 97) that corresponds to a funds-less transaction, or a pre-existing code, such as 99, can be used, although that code is typically associated with a refund transaction.

Taking the example of a discount/rebate incentive program, a desired amount of funds can be posted to the account of customer 101 without any actual real funds transfer to the USPS, thereby effectively giving customer 101 a discount. In the example of a revenue sharing program, funds can be posted to an account of vendor 102, who can then close the account and issue a money refund to itself.

This method is preferred since it keeps the records relating to real funds transfers separate from those relating to funds-less operations and is thus easier for the USPS and vendor 102 to track. Furthermore, these transactions can be performed at any time thereby allowing application of the incentive program in a highly flexible manner (e.g., retroactive discounts, etc.), without being tied to a particular subject transaction.

However, in other exemplary embodiments, one single record can be used in records transfer 107 to reflect both real funds and funds-less transactions, if desired. Such a record can include an additional field that represents the fraction of which the increase in funds is apportioned to a funds-less operation. This can be desirable in an instance where a discount is applied directly to a real funds transfer.

The incentive programs described herein can alternatively be implemented by direct money transfers, if desired.

As mentioned, in addition to providing for discounts and rebates, system 100 allows for the sharing of revenue between vendor 102 and the USPS. In one embodiment, this revenue sharing can occur as a separate funds transfer as indicated by USPS-vendor revenue share transfer 108 in FIG. 1. This preferably occurs by vendor 102 issuing a funds-less re-credit operation to one of the vendor's own accounts and then issuing a money refund to itself, although other methods including a direct money transfer from the USPS can also be used. In another embodiment, vendor 102 can retain the appropriate revenue share amount from funds collected from customers 101. The revenue share transfer 108 can be in addition to or in place of the service fee that vendor 102 charges to customer 101.

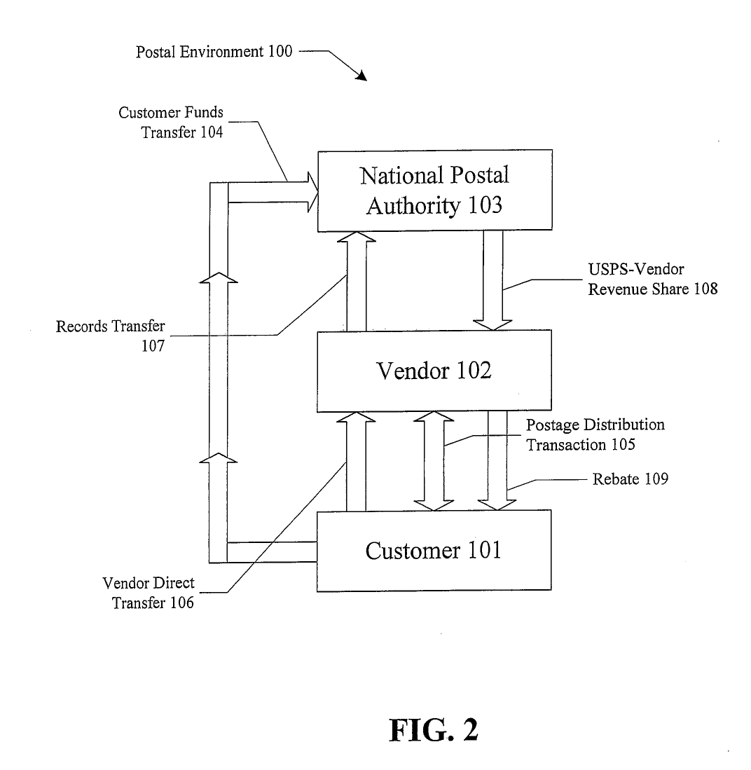

FIG. 2 is a block diagram depicting another exemplary embodiment of the system 100. This embodiment is similar to the embodiment of FIG. 1 with the addition of rebate 109 provided from vendor 102 to customer 101. If desired, rebate 109 can be provided by vendor 102 based on all or part of revenue share 108 received from the USPS. Vendor 102 can use a selective portion of revenue share 108 for its own purposes and then transfer another portion of revenue share 108 to customer 101 in the form of rebate 109. Alternatively, the entirety of the revenue share 108 corresponding to customer 101 can be provided to customer 101 as rebate 109.

Vendor 102 can provide rebate 109 in any form in which it sees fit. Rebate 109 can be provided to customer 101 as cash, as a credit to customer 101's account, as a credit to future transactions from customer 101, as credit against the service fee charged to customer 101, as a credit towards future service fees that might be incurred by customer 101, or as part of a rewards program where customer 101 earns reward points or some metric of an equivalent nature, similar to those used by conventional banks, hotels and airlines, just to name a few. Furthermore, rebate 109 can be provided to customer 101 in the form of free or reduced price supplies provided by vendor 102, such as labels or accessories like printers, scales, etc. In another example, rebate 109 can be provided as a credit to customer's accounts at other third-party suppliers, such as office supply retailers, airlines, restaurants, general retailers, and the like. In such a case, vendor 102 can enter into an agreement with a third-party supplier to allow vendor 102 to provide selective rebates in the appropriate form as desired by that supplier, e.g., as a coupon or as frequent flier miles, or as award points, etc.

In another exemplary embodiment, vendor 102 manages incentive program schedules for one or more customers 101. The schedules can be set by vendor 102 or the USPS. These schedules provide the criteria through which customer 101 qualifies for discounts (i.e., reduced fees for each postage distribution transaction 105) or rebates 109. As mentioned above, a particular schedule can make use of any criteria for determining the discount or rebate received by the customer. The schedule can generate an aggregate discount or a per transaction discount. For example, a customer can have a schedule providing them with an aggregate USPS rebate of five percent for two hundred qualifying postage transactions and seven percent for five hundred qualifying postage transactions within a specified time period.

Vendor 102 preferably manages the schedules provided by vendor 102 and/or the USPS, for example, by determining which schedules can be offered to a particular customer 101, determining whether that customer 101 then subsequently qualifies for the discount/rebate, and then applying that discount/rebate to customer 101's account or purchases. This is particularly desirable because it allows the full or standard postage rate to be printed on the customer's mail piece or label while at the same time allowing the customer to obtain a reduced price through the discount/rebate process. The printing of reduced prices on the mail piece or label often generates confusion at the local post offices since the postal employees regularly check to ensure the proper postage has been paid and, keeping these multitudes of employees abreast of the various discounted rates that are offered to the many various shippers is not practical and can be extremely burdensome.

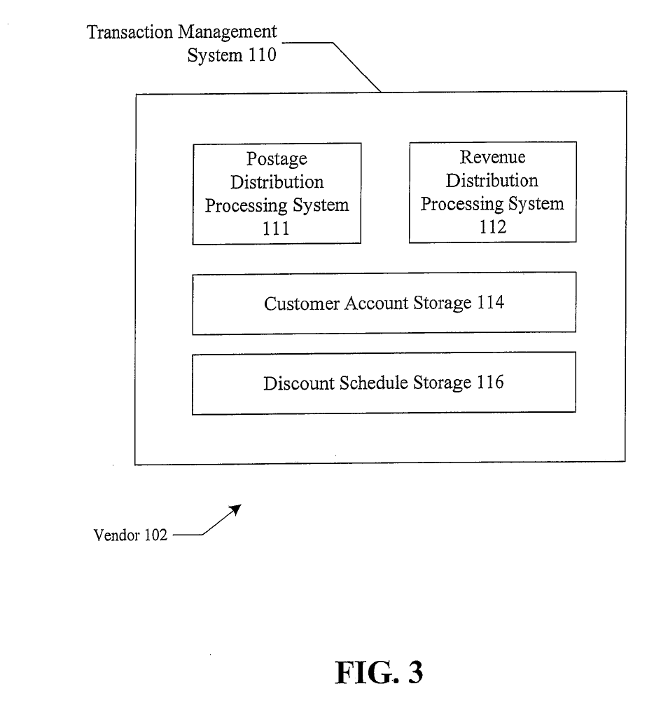

Because the complexity of the schedule management process increases exponentially as the number of available schedules and the number of customers increases, vendor 102 preferably manages the discount schedules with transaction management system 110 depicted in FIG. 3. Transaction management system 110 can include postage distribution processing system 111, revenue distribution processing system 112, customer account storage 114 and discount schedule storage 116. Transaction management system 110 can be a centrally located system or can have one or more of the components (or portions thereof) distributed across a larger geographic region.

Postage distribution processing system 111 is preferably configured to process requests for postage, confirm the request, confirm the presence of adequate funds, and generate the corresponding indicia.

Customer account storage 114 is data stored within system 110 that describes the customer as well as the customer's monetary account. This information can be used in verifying customer 101, verifying requests from customer 101, and storing the customer's postage distribution transaction 105 data.

Discount schedule storage 116 is data stored within system 110 that describes the available discount schedules as well as criteria for those schedule's application to customers and their transactions 105. Postage distribution processing system 111 is configured to then transmit the generated indicia to customer 101.

Revenue distribution processing system 112 is preferably configured to manage the discount schedules in relation to the customer's transaction activities and generate notifications when discounts are available to customer 101. Revenue distribution processing system 112 is preferably further configured to manage revenue transfer 106 from vendor 102 to the USPS as well as to track various customer-vendor funds transfers 104 as they occur. System 112 can be further configured to track received revenue shares 108 and to process deductions therefrom. System 112 is also preferably configured to generate rebates 109 as required.

Because of the effort in managing the schedules required by vendor 102, vendor 102 can charge a fee to customer 101 in return for managing the discount schedule for that customer. This fee can be deducted from a portion of the discount to which the customer qualifies. In one exemplary embodiment, if a customer qualifies for a five percent discount, four percent of that discount can be transferred to the customer while vendor 102 retains the remaining one percent as a fee for managing the schedule. Alternatively, this fee can be in the form of an outright service charge to customer 101 that is applied on a transaction-by-transaction basis or is applied on a periodic basis.

Also, this fee can be paid in whole or in part by the USPS or, in other words, the USPS can assume the role of compensating vendor 102 for its services. The fee can be a fixed or variable amount based on any desired metric. For example, the USPS can elect to allow vendor 102 to retain or earn a set, incremental and/or variable percentage or outright fee above what is provided in the discount schedule to compensate vendor 102 for managing the schedule. The percentage can be based on the aggregate amount of discounts received by an aggregate number of customers 101. Vendor 102 can receive the compensation for managing the discount schedules directly from the USPS or receive the compensation as part of each customer 101's discount.

As mentioned previously, customer payment of postage charges to the USPS as well as the payment of service fees to vendor 102, while certainly possible, is not particularly efficient. In one exemplary embodiment, the vendor's service fee is integrated into the charge for postage distribution transaction 105, e.g., the charge for a postage transaction can be increased by an amount to cover the service fee with the difference being paid directly to vendor 102. For instance, if customer 101 purchases postage with a face value of $4.60, then the customer's account can be charged a purchase amount of $4.60 plus a set fee or percentage that is applied towards the service fee. If vendor 102 charges a $0.20 set service fee for the transaction, then the customer is charged a single purchase amount of $4.80 for the postage transaction. Thus, customer 101 pays a single amount of $4.80 for the postage transaction instead of paying two separate amounts of $4.60 to the USPS through vendor 102 and a separate amount of $0.20 to vendor 102 for the service fee.

The service fee can also be integrated into the customer's postage purchase in cases where the customer pays for postage up front. For instance, if a customer purchases one hundred dollars in postage to be used as the customer later sees fit, the service fee can be charged directly from the customer's amount.

The service fee component could appear as a special service linked to the postage charge and be deducted from customer 101's overall balance just like a typical postage transaction would be deducted. A record of the transactions can be transmitted to USPS from vendor 102 periodically. This transaction record can include the amount and number of transactions and the portions of which were directed to postage as well as the service fee. In one embodiment, the service fee is a relatively low percentage (e.g., less than 10%) so as to minimize the psychological impression on customer 101.

A record of a postage transaction integrating the postage charge and the service fee can be transmitted from vendor 102 to the USPS in one or more transactions. For example, vendor 102 can transmit one transaction for the postage charge to the USPS and another transaction to the USPS for the service fee. In this example, if the purchase amount is $4.80 including $4.60 for the postage charge and $0.20 for the service free, then vendor 102 transmits one transaction to the USPS of $4.60 for the postage charge and another transaction of $0.20 for the service charge. The second transaction gives the USPS a record of the service fee owed to vendor 102. Instead of transmitting two transactions, vendor 102 can transmit one transaction, in which the transaction includes a special service indicator indicating the portion of the purchase amount to be applied to the service fee. For example, if the purchase amount is $4.80 including $4.60 for the postage charge and $0.20 for the service fee, then vendor 102 transmits one transaction to the USPS of $4.80 with a special service fee indicator indicating that $0.20of the $4.80 is to be applied to the service fee for vendor 102. The special service fee indicator can be similar in format to the indicators used for, e.g., indicating Certified Mail or Delivery Confirmation.

At the end of a specified time period, vendor 102 and the USPS can audit this record and compile the special service fee portion owed to vendor 102. This portion can be issued back to vendor 102 in the form of a payment or can be credited to a postage account in the name of the vendor, which vendor 102 can convert to compensation by issuing a refund or an account closure for the vendor postage account similar to conventional USPS protocols for closed accounts. Customer 101 throughout this process only sees one purchase amount, which includes the postage and the service fee. This streamlines the billing process, making it easier for the customer to understand.

If the USPS provides a revenue share 108 to vendor 102, vendor 102 can then transfer portions of the revenue share to customer accounts if vendor 102 chooses to rebate part of revenue share 108 to customers. For example, suppose vendor 102 receives a 3% commission from the USPS for postage transactions from customers A and B resulting in a commission of $300 for customer A and $150 for customer B. In this example, the USPS can issue a credit to the vendor's account in the amount of $450 increasing the balance in the vendor's account accordingly (or can simply transfer funds to the vendor 102 by check, money transfer etc.). Vendor 102 can rebate the entire amount to customers A and B, in which case the vendor transfers $300 from its account to customer A's account and $150 from its account to customer B's account. Alternatively, vendor 102 can rebate only a portion of the revenue share to customers A and B. For example, if the vendor rebates a third of the commission to customers A and B, then vendor 102 transfers $100 from its account to customer A's account and $50 from its account to customer B's account.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure.

What is claimed is:

1. A method of issuing a discount to a United States Postal Service (USPS) customer in an internet-based postage distribution environment, comprising:
performing a postage transaction for a customer at a postage distribution vendor, comprising:
receiving a postage request from the customer over an internet communication channel, wherein the request is for data corresponding to a postage indicium having a postage value amount associated therewith;
verifying that the customer has sufficient balance in a postage account to allow a transfer of the postage indicium data to the customer; and
electronically transmitting the postage indicium data from the vendor to the customer; and
issuing a discount to the customer, wherein the discount is at least in part based on the postage transaction.

2. The method of claim 1, wherein performing the postage transaction further comprises:
decreasing the customer's account balance by the postage value amount; and
electronically transmitting a first record of the customer's account balance to the USPS subsequent to decreasing the balance.

3. The method of claim 2, wherein issuing the discount to the customer comprises:
increasing the customer's account balance by an amount corresponding to the discount; and
electronically transmitting a second record of the customer's account balance to the USPS subsequent to increasing the balance.

4. The method of claim 3, wherein the second record comprises information indicating that the increased account balance results from a funds-less account operation.

5. The method of claim 3, wherein the second record comprises a field indicating that the increased account balance corresponds to a discount.

6. The method of claim 5, wherein the account balance is greater than the postage amount value.

7. The method of claim 5, wherein the balance in the customer's account is a result of a postage purchase transaction funds transfer.

8. The method of claim 1, wherein a plurality of postage transactions are performed with the customer and the discount is issued based on the plurality of postage transactions.

9. The method of claim 8, wherein the discount is at least in part based on the volume of the plurality of postage transactions.

10. The method of claim 8, wherein the discount is at least in part based on the aggregate value of the plurality of postage transactions.

11. The method of claim 8, wherein the discount is at least in part based on the mail class for each of the plurality of postage transactions.

12. The method of claim 1, wherein the discount is issued retroactively.

13. The method of claim 1, further comprising:
printing a postage indicium corresponding to the postage indicium data for a mail piece, wherein the postage indicium comprises a text display corresponding to the standard rate of postage for that mail piece.

14. The method of 13, wherein the text display is the standard rate.

15. The method of 13, wherein the text display is the full postage value amount.

16. A method of revenue sharing in a postal distribution environment, comprising:
performing a postage transaction for a customer at a postage distribution vendor, comprising:
receiving a postage request from the customer at the vendor;
applying a monetary representation towards the postage request, wherein the monetary representation corresponds to funds transferred from the customer through the vendor to a postal authority; and
electronically transmitting data corresponding to a postal indicia from the vendor to the customer in response to the request; and
receiving a revenue share at the vendor based on the postage transaction, wherein the revenue share is from the postal authority.

17. The method of claim 16, wherein the revenue share is based on a volume of postage purchased by the customer.

18. The method of claim 17, wherein the revenue share is based on classes of postage purchased by the customer.

19. The method of claim 16, wherein the revenue share is based on a volume of postage purchased by an aggregate number of customers.

20. The method of claim 16, wherein the revenue share is based on a volume and class of postage purchased by the customer.

21. The method of claim 16, wherein the vendor receives the revenue share by retaining a portion of the funds transferred from the customer in the amount of the revenue share.

22. The method of claim 16, wherein the vendor receives the revenue share by transferring funds in the amount of the revenue share from the postal authority to a vendor account.

23. The method of claim 16, further comprising transferring a portion of the revenue share from the vendor to the customer.

24. The method of claim 23, wherein the portion of the revenue share is transferred to the customer in the form of credit that can be applied to future postage purchases.

25. The method of claim 23, wherein the portion of the revenue share is transferred to the customer in the form of free products, discounted products and/or reward points.

26. A method of managing incentive program schedules in a postal distribution environment, comprising:
performing a postage transaction for a customer at a postage distribution vendor, comprising:
receiving a postage request from the customer at the vendor;
applying a monetary representation towards the postage request, wherein the monetary representation corresponds to funds transferred from the customer through the vendor to a postal authority; and
electronically transmitting data corresponding to a postal indicia from the vendor to the customer in response to the request;
applying an incentive program schedule to the postage transaction at the vendor to determine an incentive for which the customer qualifies; and
collecting a service fee at the vendor for managing the incentive program schedule.

27. The method of claim 26, wherein the customer qualifies for a discount and wherein the vendor collects the service fee by deducting the service fee from the discount for which the customer qualifies.

28. The method of claim 26, wherein the customer qualifies for a rebate and wherein the vendor collects the service fee by deducting the service fee from the rebate for which the customer qualifies.

29. The method of claim 26, wherein the vendor collects the service fee by having the postal authority pay the service fee to the vendor.

30. The method of claim 25, wherein the postal authority pays the service fee by transferring funds in the amount of the service fee from the postal authority to a vendor account.

31. The method of claim 26, wherein the vendor collects the service fee by charging the customer directly for the service fee.

32. The method of claim 26, wherein the incentive program schedule includes a incentive based on volume of postage purchased by the customer.

33. The method of claim 26, wherein the incentive program schedule includes an incentive based on a class of postage purchased by the customer.

34. The method of claim 26, wherein the incentive program schedule includes an incentive based on a volume of postage purchased by an aggregate number of customers.

35. The method of claim 26, wherein the incentive program schedule includes an incentive based on a volume and class of postage purchased by the customer.

36. The method of claim 26, wherein the incentive program schedule is established by the postal authority.

37. A method in a postal distribution environment, comprising:
performing a postage transaction for a customer at a postage distribution vendor, comprising:
receiving a postage request from the customer at the vendor;
applying a monetary representation towards the postage request, wherein the monetary representation corresponds to funds transferred from the customer through the vendor to a postal authority; and
electronically transmitting data corresponding to a postal indicia from the vendor to the customer in response to the request; and
charging a service fee for the postage transaction;
integrating the service fee with a postage charge charged by a postal authority into a single purchase amount; and
presenting the single purchase amount to the customer.

38. The method of claim 37, further comprising:
reporting the postage transaction to the postal authority, comprising:
transmitting a first transaction from the vendor to the postal authority in the amount of the postage charge; and
transmitting a second transaction from the vendor to the postal authority in the amount of the service fee; and
maintaining a record of the service fee at the postal authority based on the first and second transactions.

39. The method of claim 38, further comprising transferring funds from the postal authority to a vendor account in the amount of the service fee.

40. The method of claim 37, further comprising:
reporting the postage transaction to the postal authority by transmitting a transaction from the vendor to the postal authority in the amount of the single purchase amount, wherein the transaction includes an indicator indicating a portion of the single purchase amount to be applied to the service fee; and
maintaining a record of the service fee at the postal authority based on the received transaction.

41. The method of claim 40, further comprising transferring funds from the postal authority to a vendor account in the amount of the service fee.

42. A method of issuing a rebate to a United States Postal Service (USPS) customer in an internet-based postage distribution environment, comprising:
performing a postage transaction for a customer at a postage distribution vendor, comprising:
receiving a postage request from the customer over an internet communication channel, wherein the request is for data corresponding to a postage indicium having a postage value amount associated therewith;
verifying that the customer has sufficient balance in a postage account to allow a transfer of the postage indicium data to the customer; and
electronically transmitting the postage indicium data from the vendor to the customer; and
issuing a rebate to the customer, wherein the rebate is at least in part based on the postage transaction.

43. The method of claim 42, wherein performing the postage transaction further comprises:
decreasing the customer's account balance by the postage value amount; and
electronically transmitting a first record of the customer's account balance to the USPS subsequent to decreasing the balance.

44. The method of claim 43, wherein issuing the rebate to the customer comprises:
increasing the customer's account balance by an amount corresponding to the rebate; and
electronically transmitting a second record of the customer's account balance to the USPS subsequent to increasing the balance.

45. The method of claim 44, wherein the second record comprises information indicating that the increased account balance results from a funds-less account operation.

46. The method of claim 44, wherein the second record comprises a field indicating that the increased account balance corresponds to a rebate.

47. The method of claim 46, wherein the account balance is greater than the postage amount value.

48. The method of claim 46, wherein the balance in the customer's account is a result of a postage purchase transaction funds transfer.

49. The method of claim 42, wherein a plurality of postage transactions are performed with the customer and the rebate is issued based on the plurality of postage transactions.

50. The method of claim 49, wherein the rebate is at least in part based on the volume of the plurality of postage transactions.

51. The method of claim 49, wherein the rebate is at least in part based on the aggregate value of the plurality of postage transactions.

52. The method of claim 49, wherein the rebate is at least in part based on the mail class for each of the plurality of postage transactions.

53. The method of claim 42, further comprising:
printing a postage indicium corresponding to the postage indicium data for a mail piece, wherein the postage indicium comprises a text display corresponding to the standard rate of postage for that mail piece.

54. The method of 53, wherein the text display is the standard rate.

55. The method of 53, wherein the text display is the full postage value amount.
